(19) United States
(12) Patent Application Publication
(10) Pub. No.: US 2017/0206322 A1
(43) Pub. Date: Jul. 20, 2017

(54) Medical Records System and Method

(71) Applicant: Pratap Kumar, Nairobi (KE)

(72) Inventor: Pratap Kumar, Nairobi (KE)

(21) Appl. No.: 15/479,293

(22) Filed: Apr. 5, 2017

Related U.S. Application Data
(63) Continuation of application No. PCT/IB2015/057608, filed on Oct. 5, 2015.

(30) Foreign Application Priority Data
Oct. 6, 2014 (KE) KE/UM/2014/00462

(51) Int. Cl. G06F 19/00

(52) U.S. Cl. CPC G06F 19/322; G06F 19/321; G06F 19/3487

(57) ABSTRACT

The field of the invention is, in embodiments, health care including systems for maintaining medical records and communications among medical professionals. In another aspect is an improved mobile computer device comprising a camera and a communications module, wherein the improvement comprises: machine-readable instructions configured to connect the device to a network and access a structured narrative located on a server, wherein the structured narrative is configured to be displayed on the mobile computer device, and wherein the structured narrative comprises a plurality of narratives pertaining to a patient, each narrative comprising an originator identity, a date, and a data item, wherein at least one data item from at least one of the plurality of narrative comprises a hyperlinked medical image.

### CROSS-REFERENCE TO RELATED APPLICATIONS

This application claims priority to Kenyan application serial number KE/UM/2014/00462, filed 6 Oct. 2014, and PCT application serial number PCT/IB2015/057608, filed 5 Oct. 2015, the contents of which are incorporated herein by reference in their entirety.

### INTRODUCTION

The practice of medicine has become substantially more complex in the last several decades. Due to advances in medical technology, pharmaceuticals, and disease identification and treatment, medical care has become a multifaceted process that requires doctors to be constantly updating their knowledge and skill sets. Due to changes in medical care management, medical facility management, and insurance management, an increasing amount of pressure is put on medical professionals to see more patients in lesser amounts of time. Furthermore, modern communications and networking systems allow increasing amounts of collaboration among medical professionals. Systems that simplify the process of acquiring and organizing patient data are therefore becoming critical to the health care industry. Current systems of collecting, organizing, displaying, and sharing patient data are non-ideal for a variety of reasons including a lack of interoperability, inability to process certain types of data or input, hardware requirements such as non-mobile desktop platforms, and/or complex user interfaces. Improved systems for managing medical records and communications among medical professionals are therefore desirable.

### SUMMARY OF THE INVENTION

In an aspect is a computer-implemented method for managing a patient's medical records, the method comprising: receiving at a server a plurality of narratives pertaining to the patient, each narrative comprising an originator identity, a date, and a data item, wherein each data item comprises a narrative portion and a supporting data portion, and wherein at least one supporting data portion from at least one of the plurality of narratives comprises a medical image; and organizing the plurality of narratives into a structured narrative and formatting the structured narrative for display; wherein the server is configured to provide remote access to the structured narrative via a computer network, and wherein display of the structured narrative comprises a hyperlink to the medical image.

In embodiments:

the narrative portion of each data item is text and is selected from: a diagnosis; a symptom; an observation; a description or selection from an investigation; a description or selection from a report; a description or selection from a prescription; and a description or selection from a medical image;

each originator identity is selected from: a physician; a clinical officer; a nurse; a medical technician; and a patient;

at least two of the plurality of narratives are received from different originators;

the structured narrative is organized as a medical history divided into narrative groups, and within each narrative group narratives are organized chronologically;

each supporting data portion is selected from patient data and general data; and

each supporting data portion is selected from: a medical scan image; a picture or scan of a report; a picture or scan of a test result; a photo or scan of a photo (including a photo of a person or a portion of a person); a drug description; a photo or scan of a prescription; and a photo or scan of a referral.

In an aspect is a computer-based patient medical record system comprising: a structured narrative disposed on a server and configured to be displayed, the structured narrative comprising a plurality of narratives pertaining to a patient, each narrative comprising an originator identity, a date, and a data item, wherein each data item comprises a narrative portion and a supporting data portion, and wherein at least one supporting data portion from at least one of the plurality of narratives comprises a hyperlinked medical image.

In embodiments, the structured narrative is configured to be displayed on a single web page. Alternatively the structured narrative may be formatted such that different categories of the narrative may be linked on separate pages of a website, or such that certain narratives (e.g., according to a criteria such as a date) from a structured narrative are located on pages linked to a home page. Other alternatives are within the scope of the invention.

In an aspect is an improved mobile computer device comprising a camera and a communications module, wherein the improvement comprises: machine-readable instructions configured to connect the device to a network and access a structured narrative located on a server, wherein the structured narrative is configured to be displayed on the mobile computer device, and wherein the structured narrative comprises a plurality of narratives pertaining to a patient, each narrative comprising an originator identity, a date, and a data item, wherein at least one data item from at least one of the plurality of narrative comprises a hyperlinked medical image.

These and other aspects of the invention will be apparent to one of skill in the art from the description provided herein, including the examples and claims.

### BRIEF DESCRIPTION OF THE DRAWINGS

FIG. 1 is a diagram showing the composite interactions of patients, mediators, and specialists when using a system according to an embodiment described herein.

### TECHNICAL FIELD OF THE INVENTION

The field of the invention is, in embodiments, health care including systems for creating and maintaining medical records and communications among medical professionals.

### DETAILED DESCRIPTION OF VARIOUS EMBODIMENTS

Throughout this disclosure, reference may be made to “the system” or to “a system according to the invention”. Such references are meant to be equivalent and refer to any system configured to carry out the methods described herein, as well as to the components of such systems.

In an aspect is a computer-implemented method for managing a patient's medical records, the method comprising: receiving at a server a plurality of narratives pertaining to the patient, each narrative comprising an originator identity, a date, and a data item, wherein each data item comprises a narrative portion and a supporting data portion, and wherein at least one supporting data portion from at least one of the plurality of narratives comprises a medical image; and organizing the plurality of narratives into a structured narrative and formatting the structured narrative for display; wherein the server is configured to provide remote access to the structured narrative via a computer network, and wherein display of the structured narrative comprises a hyperlink to the medical image.

In another aspect is a computer-based patient medical record system comprising: a structured narrative disposed on a server and configured to be displayed, the structured narrative comprising a plurality of narratives pertaining to a patient, each narrative comprising an originator identity, a date, and a data item, wherein each data item comprises a narrative portion and a supporting data portion, and wherein at least one supporting data portion from at least one of the plurality of narratives comprises a hyperlinked medical image.

In another aspect is a mobile computer device comprising: a camera; a communications module; and instructions configured to connect the device to a network and access a structured narrative located on a server, wherein the structured narrative is configured to be displayed on the mobile computer device, and wherein the structured narrative comprises a plurality of narratives pertaining to a patient, each narrative comprising an originator identity, a date, and a data item, wherein at least one data item from at least one of the plurality of narratives comprises a hyperlinked medical image.

In another aspect is an improved mobile computer device comprising a camera and a communications module, wherein the improvement comprises: machine-readable instructions configured to connect the device to a network and access a structured narrative located on a server, wherein the structured narrative is configured to be displayed on the mobile computer device, and wherein the structured narrative comprises a plurality of narratives pertaining to a patient, each narrative comprising an originator identity, a date, and a data item, wherein at least one data item from at least one of the plurality of narrative comprises a hyperlinked medical image. As described herein, the mobile device is further capable of creating a structured narrative, including creating medical images that can be hyperlinked to a narrative.

It will be appreciated that, throughout this specification and unless otherwise indicated, any reference to a “medical image” or simply to an “image” is meant to include single images as well as a plurality of images connected so as to create a moving image (i.e., a video) with or without associated sound. Examples of medical images that are videos include a video of a seizure or disability, the gait of a person, or an investigation (ultrasound, echocardiography, electrocardiogram, etc).

### Devices

The inventive methods are computer implemented, meaning that the invention includes machine-readable instructions (i.e., computer programming code) configured to instruct a machine to carry out the various described methods. The invention is not specific to any particular programming language or operating system, and may accordingly be adapted as necessary. Portions of the machine-readable instructions may reside on a server (which may be any suitable computing device capable of coordinating the described methods, storing and updating data, running applications, etc.), whilst other portions may reside on a mobile computer device.

A mobile computing device (also referred to herein as “mobile device”) has a touch screen as an I/O device and may further comprise any of the following in any combination: a stylet, a physical keyboard, a case, a flash for a camera, and one or more speakers. The mobile device may be a tablet, mini-tablet, slate, hybrid, or the like. The mobile device is typically larger than a cellular phone and may have a screen size in the range of 7-15 or 7-13 or 7-11 inches (measured on the diagonal). In embodiments the mobile device has a screen size of greater than 7, 8, 9, 10, 11, 12, or 13 inches diagonal. It will be appreciated that the distinction between “cellular phone” and other mobile devices is changeable and, in embodiments, it may be suitable for a cellular phone to be the mobile computing device (provided that the cellular phone satisfies the requirements of the mobile device described herein).

The mobile device comprises a digital camera. The digital camera is integrated into the mobile device and may be of any suitable quality and resolution, provided that the resolution is sufficient to allow for photos and scans of medical documents or videos with sufficient clarity for users of the systems and methods described herein. The camera may be paired with a flash such that photos can be taken in low-light situations. In embodiments, the camera is able to access a memory component of the mobile device such that photos taken with the camera can be stored for later transmission or retrieval. This is particularly suitable where the mobile device is intended to be used in areas without mobile communications or internet access, so that photos taken with the mobile device can be later uploaded to the server.

The mobile device comprises a communications module. The communications module is configured to transmit and receive data. In embodiments the communications module comprises a SIM and associated circuitry to enable the mobile device to access a cellular network to transmit and receive data. The cellular network may be of any suitable variety, such as a 3G or 4G network, or the like. In embodiments the communications module uses radiofrequency (RF) signals such as via a WiFi, WiMAX, or the like to transmit and receive data. The communications module is used by the mobile device to communicate with the server (described herein) in order to, inter alia, update, receive, and display patient medical records.

The mobile device is capable of executing an application (i.e., machine-readable instructions that form an application) to carry out the methods described herein.

The system comprises a server and one or more mobile devices (e.g., a plurality of mobile devices may be used for a plurality of users). The server operates to store (either as backup or as primary storage) patient medical records and to facilitate interaction with the various mobile devices that may be in operation. The server therefore comprises a data storage component and an application comprising machine-readable instructions for carrying out the methods described herein. Each mobile device also comprises an application comprising machine-readable instructions for carrying out the methods described herein, and further optionally comprises a data storage component. The server may be a dedicated server (i.e., running only the application described herein) or may be a general purpose server. Similarly, the mobile device may be a dedicated mobile device (i.e., running only the application described herein) or may be a general purpose mobile device. The server is connected to a network and is configured to communicate with the mobile devices.

In embodiments, the mobile device (via functionality including the camera and communications module of the mobile device) may be used to generate medical images/videos and other components of narratives, such that the mobile device may be used to create all or a portion of the structured narrative.

### Methods

The methods and devices involve patient medical records. A patient is registered in the system by creation of a “patient medical record,” which includes information pertaining to that patient. Accordingly, a patient medical record comprises general identification information, a structured narrative, and further optional information such as insurance information, correlation of the patient medical record with another patient medical record for the same patient, or the like. A patient may be associated with more than one patient medical record, such as where the patient has multiple medical conditions. Where two patient medical records exist for a single patient, the two records may or may not reference (and/or be linked to) one another.

General identification information associated with the patient medical record may include any combination of the following information about the patient: name, age, location, sex, race, identification number(s) (e.g., government issued number(s) and/or a number generated by the system, wherein such numbers may be numerical or alphanumerical), vital information (e.g., height, weight, blood type, etc.), and the like. Such information is input when a patient is registered in the system, and may be updated or augmented as needed.

The patient medical record comprises a structured narrative. The structured narrative comprises one or more narratives pertaining to a medical condition. Each narrative is assigned (along with any similar narratives) to a narrative group. The narratives in a narrative group are displayed together (e.g., in chronological order of creation, or in chronological order according to the last update of the narrative, or in chronological order of events in the history of the medical condition) to aid the user with processing the data. In an embodiment, the order of the narratives in a narrative group may be changed by the user according to a criteria of the user's selection (e.g., chronological, by originator, etc.). Narrative groups include history of current illness, past medical history, medication history, allergies, family history, social history, review of systems, physical examination, and summary of the investigations. Other narrative groups may be used as needed.

Each narrative in a structured narrative comprises an originator identity, a date, and a data item. Each narrative optionally further comprise a location and a comment. These are explained in more detail below.

Each narrative comprises an originator identity. The originator identity is the identity of the person or institution responsible for creation of a narrative (i.e., the “originator”). In embodiments, an originator is selected from a physician, a clinical officer, a nurse, a medical technician, and a patient. In some embodiments patients do not have the ability to create narratives and therefore cannot be originators. Originators typically will have an originator account with the system, thereby allowing the originator to log into the system, and access and edit a patient medical record. In embodiments, a structured narrative may comprise narratives that are created by different originators (e.g., two different doctors each create one narrative in the structured narrative). Thus, a patient medical record may be the product of numerous different originators working in the same or different locations and at the same or different times. In other embodiments, the mediator (local nurse, CO, doctor, etc.) is tasked with creating and editing the narrative. The remote specialist creates a report that is then linked to an appropriate place within the structured narrative.

Each narrative comprises a date. The date is, typically, the date (which may include a time) upon which the narrative is created. In embodiments the date may be the last date upon which the narrative was edited. In embodiments, the narrative may store a plurality of dates corresponding to the date upon which it was created as well as the date(s) upon which the narrative is edited.

Each narrative optionally comprises a location. The location is, typically, the location at which the narrative was first created (i.e., the location of the originator when he/she created the narrative). In embodiments, the location may be the location at which the narrative was last updated. In embodiments, the narrative may comprise a plurality of locations corresponding to the location at which it was created as well as the location(s) at which the narrative is edited.

Each narrative optionally comprises a comment. The comment may be input by the originator or by a third party such as a network or system administrator or a remotely located clinical specialist. The comment may contain any information applicable to the narrative.

Each narrative comprises a data item. Each data item comprises a narrative portion and a supporting data portion. The narrative portion and the supporting data portion are associated such that they appear together in any rendering of the structured narrative.

The narrative portion of a narrative is generally limited to text and is selected from: a diagnosis; a symptom; an observation; a description or selection from an investigation; a description or selection from a report; a description or selection from a prescription; and a description or selection from a medical image.

The supporting data portion of a narrative relates to the corresponding narrative portion, and provides further information about the same. The supporting data portion is generally not limited to any particular data type. In embodiments the supporting data portion is selected from patient data and general data. Patient data is supporting data that is specific to the patient—e.g., data collected from or about a specific patient. General data is supporting data that is not specific to the patient—e.g., data that can be applicable to many patients. Examples of patient data include a medical scan image, a photo or scan of a report, a photo or scan of a test result, a photo or scan of a photo, a photo or scan of a prescription, a photo or scan of a referral, an investigation, and a photo or scan of an investigation. Examples of general data include a drug description, a medical condition description, and reference photos such as of a symptom or sign of a medical condition.

The supporting data may comprise text and/or a hyperlink. The hyperlink may link to any of the above items, such as photos or scans. Where the supporting data comprises general data, the general data may be stored locally on the server or may be stored externally and obtained via the Internet from a third party. Thus the hyperlink may link to an external third party website or may link to data stored locally on the server. Where the supporting data comprises patient data, the hyperlink will generally link to the data stored locally on the server (or on the mobile device). In embodiments, every narrative in a structured narrative comprises a hyperlink within the supporting data. In embodiments, greater than or equal to 10, 20, 30, 40, 50, 60, 70, 80, or 90% of the narratives in a structured narrative comprise a hyperlink within the supporting data.

Throughout this disclosure, references are made to a “mediator,” by which is meant a locally registered medical professional (nurse, clinical officer, doctor, or the like) who mediates the entire consultation process using the methods and systems described herein. In embodiments, the mediator has all or some of the following tasks: (a) create the patient narrative (often involving a face-to-face meeting with the patient or patient representative); (b) identify available data (e.g., medical records, investigations, etc., some of which may have come from the first medical professional as described herein), digitise data, and link the digitized data to the narrative; (c) identify appropriate specialists to consult and share the structured narrative; (d) once a specialist commits to turning around the case for a second opinion, share the full structured narrative with that specialist and optionally schedule an appointment for a phone consultation; (e) respond to any doubts and requests for additional information from the specialist; (f) initiate and mediate the phone consultation between patient and specialist; (g) counsel the patient on next steps based on the specialist second opinion; (h) ensure a specialist report is received and linked to the narrative; and (i) follow-up with the patient. Any subset of the above tasks may be required of the mediator. In some embodiments the mediator and the first medical professional (as described herein) are the same, although in other embodiments the mediator and the first medical professional are different individuals.

### Security and Privacy

The systems of the invention may be configured to ensure privacy and security of the data. Particularly, each patient medical record is visible only to the originator of the data and to any individuals authorized according to a protocol (e.g., authorized by the patient or by the originator of the data). Data is encrypted during transmission and may further be encrypted when stored on the server and/or on the mobile device. In embodiments, the data may be stored separately from the application (e.g., on different servers or on partitioned portion of a single server). In embodiments, patient information (e.g., age, sex, location, insurance status, etc.) and medical information (i.e., the narrative) may be stored separately on different servers or partitioned on the same server. Where necessary or desired, options may be provided for anonymizing data—i.e. removing any identifying labels attached to the data, particularly when transmitting the data or providing access to the data. In embodiments, the data may be segmented such that only portions of a patient medical record is available to specific users.

In embodiments, audit trails/logs are kept for some (or all) data in a patient medical record and include nature of changes, user who effected changes, and time of changes.

A set of components may be provided to allow collection of metrics such as page views by logged in users or anonymous users and other events (e.g. creating/updating a patient record) within the system. These may form the basis of various reports and dashboards. Collection of such metrics may also negate the need for audit functionality, although such functionality can be included.

In embodiments dashboards are provided to give administrators access to various reports including but not limited to: number of new cases created, access to individual cases, cases ‘open’ for consultations, cases ‘closed’, turn-around times for consultations, outcomes of consultations, follow-up data after consultations, etc.

Certain patient data may not be suitable for uploading and storage on the system. Such data may be found on documents that are scanned or otherwise input into the narrative. In embodiments, it will be known at the time of input that certain data is private and not suitable for the narrative. In other embodiments, it may be determined at a time after the initial input of the data that certain parts of the data are private and not suitable or desirable for the narrative. Accordingly, the systems described may include a redaction module configured to redact data from documents. In embodiments, the redaction module allows selective redaction of a document (e.g., removal or obscuring of sensitive information, private information, irrelevant information, etc.) at the time that a document is input and uploaded on the data capture device (e.g., on a table used by the medical professional). For example, the redaction module includes a mechanism for digitally drawing a box or other shape over an area of a document or image intended for redaction and deleting any underlying data. In embodiments, the redaction module is an option available for redacting documents that were previously uploaded into the narrative. In embodiments, the redaction module allows redaction at both times—upon initial input of the document as well as at a later time for documents previously uploaded. In embodiments, upon redaction with the redaction module, the redacted document is stored in the narrative and the non-redacted (original, unmodified) is deleted from the system. In such embodiments the original data is lost upon redaction. In other embodiments, the system may store a copy of the non-redacted document such that the original data is not irrevocably lost upon redaction. In such embodiments, the non-redacted document will typically be secured and made accessible only to a system administrator or the like.

### Input and Output

In embodiments, a patient medical record may be created on a mobile device, meaning that a patient is registered and the narratives are entered entirely from the mobile device. The patient medical record may be stored locally on the mobile device either permanently or temporarily (e.g., where the mobile device is out of communication range, the patient medical record can be created and stored locally until such time that the mobile device is able to regain communications with a network and upload the patient medical record to the server). Alternatively the patient medical record can be stored only on the server—in such cases the mobile device is granted read/write access to the record but does not store a local copy of the record. Such embodiments are “fully mobile” in that they require a connection to the server at all times of operation. In embodiments, patient registration may be carried out on a desktop computer, at which time the patient medical record is created. Creation and/or uploading of narratives can be carried out at a later time.

In embodiments the mobile device is suitable and configured to enable creation of narratives and of the structured narratives. For example, the camera on the mobile device is suitable to create a digital image of a document or to take a picture or video of a sign of a medical condition (e.g., a lesion, etc.) and the application instructions on the mobile device can facilitate uploading such image into the structured narrative. Furthermore, the communications module on the mobile device is suitable and configured to enable communication (downloading and uploading) of patient medical records and the data contained therein, and in supporting a case discussion by medical professionals.

In embodiments, the structured narrative is configured to be displayed on a single web page. Such webpage may be optimized for viewing on the mobile devices that are supported by the system—e.g., tablets with a specific screen size, etc. While viewing a structured narrative, the user can select a hyperlink to see data thereby linked. For example, a narrative may comprise a medical scan image or video as part of the supporting data. The supporting data may thus comprise a title indicating the type of data and a hyperlink that links to the actual image. The user can select the hyperlink to view the image (which may be displayed as an entirely separate page or within a viewing window in the application).

Where the supporting data portion comprises a scan image (e.g., an image from an investigation), the data can be displayed directly as the image itself in a special viewer or can be converted to a file format that is recognized by standard image viewing software. For example, an Electrocardiogram or EEG scan could view viewed as a PDF document or directly in an application that renders the Electrocardiogram.

The data is structured as described herein for the purpose of, inter alia, facilitating remote and online consultations (including second opinion consultations and the like). Data is easy to input (e.g., scans, photos, etc.) and is easy to read, in a structure that allows consulting professionals to understand the data quickly. Little or no training is required due to a user interface that is intuitive and simple. Confidentiality is maintained (as described herein) where necessary and appropriate.

The devices described herein (e.g., tablets, mobile phones, etc.) are improved from pre-existing devices by incorporating machine-readable instructions (into a devices' memory) suitable to enable the device (i.e., the processor and associated peripherals such as a display screen, etc.) to receive input, create a structured narrative, communicate the structured narrative to a server or another device, and display the structured narrative (or any structured narrative sent to the device from a server or other remote device). Such display includes interactive display (e.g., allowing the using medical professional to view data as desired, zoom into charts, etc.).

### Use

Medical conditions suitable to be processed using the disclosed methods include both chronic and acute illnesses. Thus a patient medical record may have a structured narrative for a chronic illness that is monitored and treated over time, with narrative entries that are widely spaced in time. Alternatively, a patient medical record may have a structured narrative for an acute illness, describing the illness, diagnosis, and treatment that are relatively closer in time. In embodiments, the patient medical record relates to a single medical condition, and any subsequent medical conditions suffered by the same patient are input as a new patient medical record.

In embodiments, the systems and methods are suitable for facilitation second medical opinions from a second medical professional (also referred to herein as a “specialist”). A patient may be seen by a first medical professional (e.g., doctor, nurse, etc.) and wish for a second opinion regarding the diagnosis by the first medical professional. The first medical professional then can also act as a mediator, or an independent mediator can facilitate the process to obtain a second opinion from the specialist. The process is facilitated because the first medical professional (or the patient, or an independent medical professional (i.e., second opinion mediator) tasked to facilitate a second opinion consultation) can create the patient medical record and can include, in the structured narrative, scans and other images as supporting data. The second medical professional can, regardless of his/her location and proximity to the patient, be granted access to the patient medical record and can render a second opinion with respect to the patient's condition. The availability of the information online facilitates easy interaction between the first and second medical professional (or between the patient and the second medical professional).

The system can be configured such that alerts are automatically generated when a second opinion is requested, or when any other action is requested by a user such as a patient, first medical professional, mediator, etc.

In embodiments, the systems and methods are suitable for training medical professionals, either as a primary teaching tool for students or as a continuing education tool or decision support system for practicing professionals. The online availability of the structured narratives allows teaching a medical case history to anyone with a suitable mobile device (i.e., connected to the network upon which the server is located).

Throughout this disclosure, use of the term “server” is meant to include any computer system containing a processor and memory coupled to the processor, and capable of containing or accessing computer instructions suitable for instructing the processor to carry out any desired steps. The server may be a traditional server, a desktop computer, a laptop, or in some cases and where appropriate, a tablet or mobile phone. The server may also be a virtual server, wherein the processor and memory are cloud-based. In addition to the server, various computing devices are also mentioned herein such as tablets, laptops, and the like. Such devices also contain a processor and a memory coupled to the processor, with the memory being configured to store computer-readable instructions sufficient to cause the processor to carry out any desired steps.

The methods and devices described herein include a memory coupled to the processor. Herein, the memory is a computer-readable non-transitory storage medium or media, which may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Throughout this disclosure, use of the term “or” is inclusive and not exclusive, unless otherwise indicated expressly or by context. Therefore, herein, “A or B” means “A, B, or both,” unless expressly indicated otherwise or indicated otherwise by context. Moreover, “and” is both joint and several, unless otherwise indicated expressly or by context. Therefore, herein, “A and B” means “A and B, jointly or severally,” unless expressly indicated otherwise or indicated otherwise by context.

It is to be understood that while the invention has been described in conjunction with examples of specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. The pertinent parts of all publications mentioned herein are incorporated by reference. All combinations of the embodiments described herein are intended to be part of the invention, as if such combinations had been laboriously set forth in this disclosure.

The following are interactions that are enabled by the systems described herein.

A patient can carry out the following interactions, actions, etc. using the described systems/methods: obtain an appointment; visit a central facility for an initial consultation; supply additional data on medical case; review creative narrative, authorize sharing (including viewing patient record); counseling on medical case; follow up on medical case; set up an appointment for a second opinion consultation; carry out a second opinion consultation.

A mediator can carry out the following interactions, actions, etc. using the described systems/methods: create narrative of medical case (including creating a patient record, digitize paper record, and identify missing records, and also extending the function of updating a narrative of medical case); update narrative of a medical case (including re-order segments of a narrative, upload scans of paper records, and upload radiology items); supply additional data on medical case; receive a patient seeking an initial consultation; counsel a patient on a medical case; follow up on a medical case; review a created narrative, authorize sharing (including viewing a patient record and sharing a link to a patient's record); share a link to a patient's record (including generating a link to a patient's record); request specialist to review medical case; set up an appointment for a second opinion consultation; carry out a second opinion consultation; upload doctors' reports; upload mediator reports; and retire link to a patient record.

A specialist can carry out the following interactions, actions, etc. using the described systems/methods: receive request to review a medical case; accept a request to review a medical case; review a patient's medical record (including viewing a patient record); set up an appointment for second opinion consultation; carry out a second opinion consultation; report on a medical case (including uploading doctors' reports); and request for more data on a medical case.

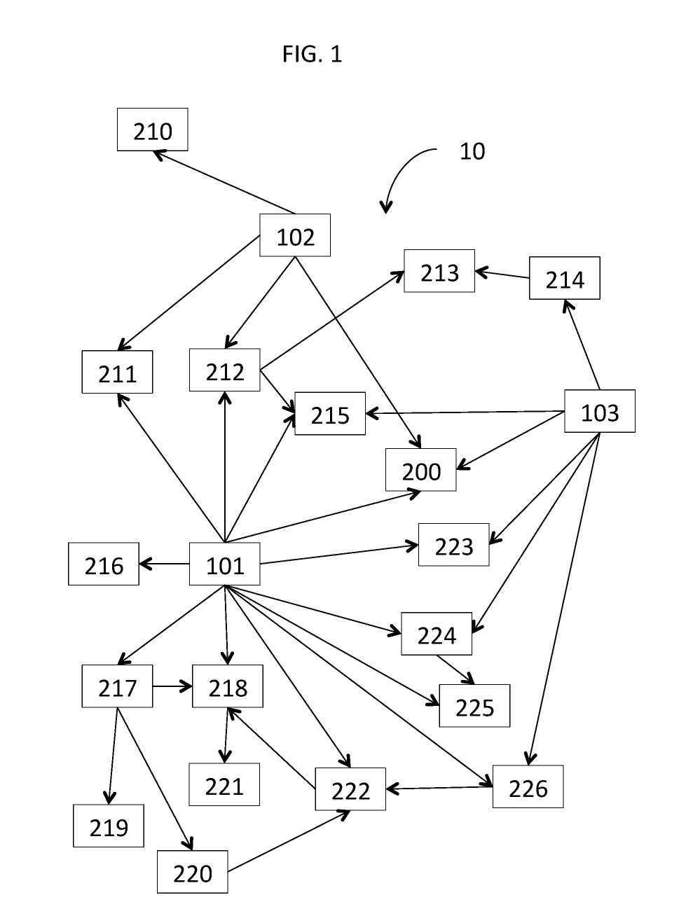

The various functionality (e.g., interactions, actions, etc.) that are described above are further illustrated with additional connectivity in the example of system 10 shown in FIG. 1. Mediator 101, specialist 103, and patient 102 are shown, each with access to various actions/functions of system 10. Thus, mediator 101 and patient 102 can each access 211, which are services including visiting a central facility for an initial consultation, supply additional data on a medical case, and counseling on a medical case. Patient 102 can access 210, which is making an appointment with the system. Mediator 101 and patient 102 can each access 212, which is to review a created narrative and authorize sharing. Function 212 includes 213 (viewing a patient record) and 215 (sharing a link to a patient's record). Mediator 101 can further access 216 (retire a link to a patient record), 217 (create a narrative of a medical case), and 218 (update a narrative of a medical case, which is also an extension of 217). Then, 217 includes various aspects such as 219 (which includes creating a patient record and digitizing paper records) and 220 (identify missing records), which includes 222 (obtain missing records). Functions 217, 222, and mediator 101 can all access 218 (update narrative of a medical case), which includes function 221 (which may include re-ordering segments of the narrative, uploading scans of paper records, and uploading radiology images). Mediator 101 can also access 222 (obtain missing patient records). Specialist 103 and Mediator 101 can both access various functions represented by 223 (e.g., request to review medical case, and accept to review medical case and 224 (report on medical case). Extensions of 224 that are also accessible to Mediator 101 are functions 225 (e.g., upload doctors' reports and upload mediator reports). Function 226 (request more data on a medical case) is also accessible to specialist 103. Specialist 103 can further access 214 (review a patient's medical record), which includes 213 (view a patient record). Specialist 103 and Mediator 101 can both access 215 (sharing a link to a patient's record). Specialist 103, patient 102, and mediator 101 can all access 200, which represents a second opinion consultation aspect (including setting up an appointment for a second opinion consultation) of the system 10.

Still further illustrative cases are provided in the examples that follow.

### EXAMPLES

### Example 1

A patient obtains an appointment. A patient, having obtained a medical diagnosis, and seeking a second opinion for his medical case, seeks an appointment. The patient is informed of what kind of documents he should come with as well as any other things to expect.

The patient visits a Mediator. He goes through a brief consultation with the mediator and presents his medical records. He is also informed of how to go about the billing process.

The patient reviews the narrative created for his medical case. After a narrative for the patient's medical case has been created, the patient reviews it with the mediator and gives his consent for his medical data to be shared with approved specialists.

An appointment is set. A patient is given an appointment to have his medical case discussed with a specialist.

The patient is requested for more information. At a later time, the patient may be asked for some more information pertaining his medical record. He supplies this. This may recur as needed.

The patient is given a medical second opinion. At a previously arranged appointment, the patient goes through a consultation with the mediator and specialist for his medical case.

The patient is counseled on his medical case and next steps. The patient receives information on how to handle his medical case and where to seek further help if need be.

The patient receives a consultation report. The patient will receive via email both the specialist's and the mediator's report.

### Example 2

A mediator meets a patient for the first time. The mediator initiates the billing process with the patient. The mediator then collects patient information that the patient provides and supplements it with information from an interview. He also digitizes the paper records available and identifies missing records if any.

The mediator creates a narrative of the patient's case. The mediator organizes the medical records and consultation notes into a narrative of the patient's case. He stores this in an online repository; uploading scans of doctors' reports, medical records, and even radiology images. The mediator will also rearrange various segments of the narrative to better express the patient's case.

The mediator obtains additional records of the patient's case. If the mediator determines the need for additional medical records for the patient's case, he requests the patient for it. The patient may authorise the mediator to obtain his medical records directly from a healthcare provider. The Mediator creates an entry in the “Updates” section in the narrative of a patient's case. The entries will contain an effective date of the update, as well as a description of the update. These will be displayed on the read-only screen of the narrative and will be sorted in descending order of the effective date of the update.

The mediator shares the narrative with the patient for approval. The mediator will generate a link to the patient's record and share this via email. The patient will review his record and approve sharing with a specialist. Additionally, the Mediator may generate more links to share with specific specialists or other persons of interest; or just for testing purposes. The Mediator will indicate the purpose of each link they generate as they generate it.

The mediator arranges for a specialist to review the medical case. At this point, the mediator will first check to confirm that the patient has settled their bill. Once done, picking from a list of available specialists in a given field, the mediator requests suitable specialists to review the medical case. If he receives a positive response, he informs other specialists that the case is no longer available to them.

The mediator shares a patient's record with a specialist. Having obtained a positive response from earlier request to review a medical case, the Mediator generates a new link to the patient record which they share with the specialist. the mediator sends a link of the patient's record to the specialist. This is the same link he generated previously for the patient. The specialist would respond with a probable time for the appointment of the second opinion consultation and possibly a request for more information on the patient's medical case.

The mediator updates a patient's record. Following a request for more information on a medical case from the specialist, the mediator goes about obtaining the missing information and updating the online repository when the data is available. The mediator will also contact the specialist to let him know that the patient's record has been updated. Each time the Mediator updates the narrative, the Mediator creates an entry in the “Updates” section in the narrative of a patient's case. The entries will contain an effective date of the update, as well as a description of the update. These will be displayed on the read-only screen of the narrative and will be sorted in descending order of the effective date of the update. They will be especially useful to the specialist to see what has been changed on the patient record.

The mediator mediates a second opinion consultation. At a previously arranged appointment, the mediator and the patient consult with the specialist regarding the medical case.

The mediator counsels a patient after the consultation. Following the consultation with the specialist and the patient, the mediator counsels the patient on understanding and managing his medical case and where to seek further help if needed.

The mediator submits a report on the second opinion consultation. The report may detail the mediator's experience of the entire second opinion consultation process as well as a summary of specialists findings and recommendations.

The mediator receives a specialist's report on the second opinion consultation. He will update the online repository of the patient's medical case with this report and will also share it with the patient along with his own report on the same case. In addition, he will make a new entry in the Updates section of the narrative.

The mediator retires generated links to a patient record. At the end of the second opinion consultation, or at any other time when the generated link(s) are no longer required, the Mediator manually retires the link(s) used to share the medical record by clicking on “Retire this Link”. The record will no longer be accessible via the specific link(s).

The mediator follows a patient's case after the second opinion consultation. From time to time, the mediator will also follow-up with the patient to find out how effective the consultation has been.

### Example 3

A specialist receives a request to review a medical case. The specialist receives a request to review a medical case via email. In the request is a summary of the case.

The specialist agrees to review a medical case. The specialist notifies the mediator of his willingness to review the medical case.

The specialist receives a link to the patient's record. In return, he receives a link to the record he should review via email. After a look at the medical record, the specialist informs the mediator on when he is available for the second opinion consultation. He may also find that he needs more information on the case in order to give a more informed opinion. He sends this request to the mediator along with his response. When the information is available, it is updated on the same repository he has been viewing the record on. He will also receive an email to notify of the update.

The specialist confirms a second opinion consultation appointment. He is informed of whether the mediator and the patient will be available at the time(s) he indicated previously. If not, the three parties arrange for a suitable time.

The specialist consults on a medical case. At the previously arranged appointment, the specialist discusses the medical case with the mediator and the patient; giving his diagnosis and recommendations.

The specialist submits a report of his consultation. This will detail the specialist's findings on the medical case and of the mediation process.

### Example 4

An Administrator Creates a PACS Data Source. From the administrative interface of PSOC, an administrator clicks on “Add a new PACS Data Source”. He fills in the pertinent information and clicks save. The Data Source is created and the user is redirected back to the administrative interface/dashboard.

The Administrator Manages an Existing PACS Data Source. From time to time, it is possible that access information to a previously added Data Source may change. At such times, the administrator will click on “Manage PACS Data Sources” on the administrative dashboard and will be redirected to a page listing existing data sources. The Administrator will select which data source they would like to update. They are presented with the details of the data source. The administrator then clicks on “Edit this Data Source” and is presented with a form where they can change any of the values that need to be updated. Patient Records with DICOM studies linked to this data source will not need to be updated. The changes to the data source are internally resolved.

The Administrator Creates a New Flag. When the need arises to create a new Flag that can be associated with a given patient's case, the Administrator logs in the the administrative dashboard of the PSOC application. They then click on “Add a New Flag”. The administrator is presented with a screen allowing them to enter the title of the flag. Once done, the Administrator clicks “Save” and the Flag is created. The Administrator is then redirected back to the screen showing all flags.

The Administrator Updates a Flag. Perhaps due to a spelling mistake, or the need for a more concise title for the Flag, the Administrator follows a link to a list of existing flags from the administrative dashboard. They select the affected Flag and click on “Edit”. They are then presented with a screen allowing them to update the title of the Flag as required. Once done, the Administrator clicks “Save” and is redirected back to the screen listing all Flags. Existing Patient Records containing the particular Flag are internally updated to reflect the changes.

The Administrator Interacts with Summary Reports. Summary reports will be available for a given date range and will be categorized as “User Level”, “External Access” and “Record Level”. Each of these items will be available on the administrator's dashboard and will least metrics relevant to the respective category. On clicking on any of the available metrics, the Administrator will be able to view more detail related to the metric; usually containing a subset of Patient Information and other information relating to the specific category the Administrator followed.

### Example 5

A medical professional (nurse, clinical officer or doctor) requires support on a case. A medical professional is managing a patient and needs support in the diagnosis or treatment. He/She asks the patient's consent for sharing medical data with appropriate medical professionals.

The medical professional creates a narrative of the patient case. The medical professional collates and digitizes relevant patient data and creates a structured narrative of the case using a system according to the disclosure.

The medical professional shares the link to the structured narrative with one or more selected specialists. After a narrative for the patient's medical case has been created, the link to the case record is shared with one or more selected specialists whose support is sought.

Remote specialist opinion received. The opinion is provided in a text report or in a phone/video discussion with the first medical professional, or both. The report or the discussion provides the first medical professional with advice or support on the treatment or management of the patient.

The patient is counseled on his medical case and next steps. The patient is managed by the medical professional as appropriate based on the advice received from the remote specialist.

### Example 6

The tables below show steps suitable for the methods described herein.

TABLE 1
User Login Steps

| Step No | Description |
|---|---|
| 1 | The Mediator visits the URL for the PSOC application |
| 2 | The Mediator is presented with a login screen |
| 3 | The Mediator puts in their username and password combination |
| 4 | The Mediator is redirected to the Patient Record Dashboard |
| 5 | The screen indicates their username, an option to view the |
| | Mediator's profile, and a link to logout |

TABLE 1a
Variations on Table 1 steps

| Step No | Description |
|---|---|
| 1a | The Mediator has an active session on the PSOC application |
| 1a1 | Proceed to Step 4 |
| 3a | The Mediator inputs incorrect credentials |
| 3a2 | The Mediator is informed that they can not login with the |
| | credentials they supplied |
| 3a3 | Proceed to Step 3 |

TABLE 2
DICOM Upload

| Step No. | Description |
|---|---|
| 1 | The Mediator obtains a set of DICOM images for a given patient's case in |
| | an optical disk or other digital medium |
| 2 | The Mediator copies these images to their computer in the PSOC directory |
| | under a sub-directory for the patient's case |
| 3 | The Mediator obtains copy of the software necessary to upload DICOM |
| | images to the DCM4CHEE server |
| 4 | The Mediator obtains credentials and connection parameters necessary |
| | to upload DICOM images to the DCM4CHEE server |
| 5 | The Mediator opens a terminal (command prompt) and navigates to the |
| | directory in his computer containing the DICOM images (see step 2 |
| | above) |
| 6 | The Mediator issues the upload command (see “dcmsnd” below) |
| | The upload commad uploads all the DICOM images in the directory to the |
| | DCM4CHEE server |
| 7 | The Mediator has completed the task |

TABLE 2a
Variations on Table 2 steps

| Step | |
|---|---|
| No | Description |
| 6a | There are non-DICOM files in the directory |
| 6a1 | The upload command issues a warning that a given file could not |
| | be parsed in the DICOM format |
| 6a2 | The upload command skips the non-DICOM file and continues |
| | with the upload process |
| 6b | There are sub-directories in the directory the Mediator has |
| | navigated to |
| 6b1 | The upload command iterates recursively into the sub-directories, |
| | uploading every DICOM file it finds |

TABLE 3
New Case

| Step No | Description |
|---|---|
| 1 | The Mediator clicks on “Create a Patient Record” link from the patient list |
| | screen |
| 2 | The Mediator is presented with a screen in which they can fill in required |
| | patient information (see patient info below) |
| 3 | The fill in the form, click “Save” and validation is performed |
| 4 | The Patient's record is saved and the Mediator is presented with a read |
| | only screen where they can review the information they just entered |
| | In addition, there are links available in this page to pages which manage |
| | other aspects of the patient record (The narrative of the case, File or |
| | DICOM Attachments available); as well as a link to edit the data they just |
| | entered |
| 5 | The Mediator clicks on “Add a File Attachment” |
| 6 | The Mediator is presented with a screen in which they can fill in required |
| | File Attachment information including selecting the file to attach (see File |
| | Attachment info below) |
| | This page will also show read-only Patient information for the current |
| | patient record |
| 7 | The Mediator fills in this form and clicks “Save” and validation is |
| | performed |
| 8 | The Mediator is taken back to the page showing read only Patient details |
| | This Page will be updated to include a list of File Attachments that the |
| | Mediator has added to the Patient record |
| 9 | The Mediator clicks on “Add DICOM Studies” |
| 10 | The Mediator is presented with a screen where they can fill in required |
| | DICOM Study information (see DICOM Studies info below) |
| | This page will also show read-only Patient information for the current |
| | patient record |
| 11 | On a seperate browser window or tab, or at an earlier time, the Mediator |
| | browses to the DCM4CHEE application |
| 12 | The Mediator searches for the Patient (in DCM4CHEE) they would like to |
| | add DICOM studies for in PSOC |
| 13 | The Mediator copies or memorises the Patient ID of the Patient in |
| | DCM4CHEE for later use in PSOC |
| 12 | Back on PSOC, the Mediator fills in this form and clicks “Save” and the |
| | system fetches all DICOM studies for the patient with the input Patient ID |
| | from the PACS server |
| 15 | The Mediator is taken back to the page showing read only Patient details |
| | This page will be updated to include a list of DICOM studies fetched from |
| | the PACS server |
| 16 | The Mediator clicks on “Create a Narrative” |
| 17 | The Mediator is presented with a page in which they can fill in the |
| | required Narrative information; including Narrative Blocks and Segments; |
| | as well as a case summary, questions for specialist and a presumptive |
| | diagnosis (see narrative info below) |
| | This page also contains read-only patient information for the current |
| | patient record |
| 18 | The Mediator fills in this form and clicks “Save” and validation is |
| | performed |
| 19 | The Mediator is taken back to the page showing read only Patient details |
| | This Page will be updated to include information added by the Mediator |
| | as pertains the Narrative they just modified |
| 20 | The mediator selects one of the segments and clinks ‘Link Attachment’ to |
| | associate one of the File Attachments or DICOM Studies to this particular |
| | narrative segments |
| 21 | A pop up presents a list of the File Attachments and DICOM studies that |
| | have been linked to this patient encounter |
| 22 | The mediator selects one of the File Attachments or DICOM studies |
| 23 | The Mediator is taken back to the page showing read only Patient details |
| | This selected segment has been update to show the name of the File |
| | Attachment or DICOM Study that has been linked to it and an ‘unlink’ |
| | option is now displayed next to this segment |
| | The selected File or DICOM Attachment has a ‘linked’ indicator next to it |
| | on the list of File Attachments displayed at the bottom of the read only |
| | screen |
| 24 | The mediator has completed the entry and clicks to return to the list of |
| | patient entries |

TABLE 3a
Variations on Table 3 steps

| Step No | Description |
|---|---|
| 3a | One or more validation constraints fails (see patient info below) |
| 3a1 | The Mediator is prompted to correct the offending entries |
| 3a2, | The Mediator corrects the entries |
| 3a3, | Retry step |
| 3b | The Mediator needs to re-order some of the narrative segments |
| 3b1 | The Mediator clicks on and drags the “drag handle” next to the particular |
| | narrative segment they want to re-order. The entire narrative segment |
| | will be moveable |
| 3b2 | The Mediator moves the particular segment to the position in should be |
| | in. |
| 3b3 | For any more segments that should be re-ordered, the mediator repeats |
| | step 4c1 and 4c2 above |
| 3b4 | Return to step 3. |
| 7a | One or more validation constraints fails (see File Attachment info below) |
| 7a1 | The Mediator is prompted to correct the offending entries |
| 7a2 | The Mediator corrects the entries |
| 7a3 | Retry step |
| 11a | One or more validation constraints fails (see narrative info below) |
| 11a1 | The Mediator is prompted to correct the offending entries |
| 11a2 | The Mediator corrects the entries |
| 11a3 | Retry step |
| 3b | The patient already exists - incorrect details (the patient ID No. already |
| | exits on the database) |
| 3b1 | The system warns the patient ID no already exits on the database |
| 3b2 | The mediator updates the patient ID |
| 3b3 | Return to step 3 |
| 3c | The patient already exists - incorrect entry (the patient ID no. already |
| | exists in the database.) |
| 3c1 | The system warns the patient ID no already exits on the database |
| 3c2 | The mediator selects to abort the entry of the patient data (failed end |
| | condition) |
| 3d | The Mediator clicks ‘Cancel’ |
| 3d1 | The systems prompts the Mediator to confirm whether they would like to |
| | abort their modifications |
| 3d2 | If the Mediator confirms to abort, the system redirects them to the list of |
| | Patient records |
| 3d3 | If the Mediator does not confirm to abort, return to step 3 |
| 7b | The Mediator clicks ‘Cancel’ |
| 7b1 | The systems prompts the Mediator to confirm whether they would like to |
| | abort their modifications |
| 7b2 | If the Mediator confirms to abort, the system redirects them to the read |
| | only screen for the patient and the File Attachment list will not be |
| | updated |
| 7b3 | If the Mediator does not confirm to abort, return to step 7 |
| 16b | The Mediator clicks ‘Cancel’ |
| 16b1 | The systems prompts the Mediator to confirm whether they would like to |
| | abort their modifications |
| 16b2 | If the Mediator confirms to abort, the system redirects them to the read |
| | only screen for the patient and the segment details will not be updated |
| 16b3 | If the Mediator does not confirm to abort, return to step 18 |
| 6a | There is more than one file to attach for this patient encounter |
| 6a1 | Details are filed out for each File Attachment and each file is selected |
| 6a2 | Continue from step seven (on returning to the read only screen the details |
| | of all the File Attachments added will be displayed |
| 24a | There are multiple segments to enter for one or more of the narrative |
| | blocks |
| 24a1 | The mediator enters the first segment details |
| 24a2 | The medaitor cliks on ‘add segment |
| 24a3 | The medaitor enters the details of the subsequent segment |
| 24a4 | 10a2-10a3 are repeated for each narrative segment |
| 24a5 | Return to step 18 |
| 24c | The Mediator has entered a segment that they should not have |
| 24c1 | The Mediator clicks on ‘Remove Segment’ |
| 24c2 | The segment is removed from the narrative |
| 24c3 | Return to step 18 |
| 24c1a | The segment is linked to an attachment or a study |
| 24c1a1 | The ‘Remove Segment’ button is not clickable and displays the tooltip |
| | “You can not remove this segment now because it has a linked attachment |
| | or study.” |
| 24c1a2 | Return to step 18 |
| 8a | The Mediator has added an File Attachment in error |
| 8a1 | The Mediator clicks on ‘Delete File Attachment’ |
| 8a2 | The Mediator is prompted if they are sure they want to delete the File |
| | Attachment |
| 8a3 | The Mediator confirms they want to delete the File Attachment |
| 8a4 | The File Attachment is removed and is no longer available to the Patient |
| | Record |
| 8a5 | Return to step 6 |
| 23a | The Mediator has added an File Attachment in error |
| 23a1 | The Mediator clicks on ‘Delete File Attachment’ |
| 23a2 | The Mediator is prompted if they are sure they want to delete the File |
| | Attachment |
| 23a3 | The Mediator confirms they want to delete the File Attachment |
| 23a4 | The File Attachment is removed and is no longer available to the Patient |
| | Record |
| 23a5 | Return to step 16 - on return to the read only screen the File Attachment |
| | is no longer shown in the list of File Attachments |
| 23a1a | The File Attachment is already linked to one or more segments |
| 23a1a1 | The button is not clickable and displays the tooltip ‘please unlink this File |
| | Attachment before deleting it’ |
| 23a1a2 | Return to step 23a2 |
| 23b | More than one segment relates to one of the File Attachments |
| 23b1 | The mediator repeats step 13-15 for each segment to which the File |
| | Attachment relates chosing the same File Attachment in the pop up each |
| | time. |
| 23b2 | Return to step 23 |
| 23c | The document was linked to the wrong segment |
| 23c1 | The mediator clicks on the ‘un-link’ option next to the segment |
| 23c2 | The link between the document and the segment is now removed |
| | The segment is updated so that the ‘link document’ link is displaye rather |
| | than the document name and ‘un-link’ link |
| | The document is updated on the list of documents at the bottom of the |
| | screen, the indicator now shows that it is not linked to a document (if |
| | there are no other segments linking to it) |
| 23c3 | Return to step 16 to link the document to the correct segment |
| 23c2a | The document is linked to more than one segment |
| 23c2a1 | The segment is updated as above but the document list is not updated as |
| | the document indicator still shows that it is linked to a document |
| 23c2a2 | Return to step 23c3 |
| 12a | The Mediator inputs a Patient ID that is already associated with a Patient |
| | Record on PSOC |
| 12a1 | The Mediator is alerted that the Patient ID is already in use and can not be |
| | re-used |
| 12a2 | The Mediator corrects their entry, inputing another Patient ID |
| 12a3 | Proceed to step 12 |
| 12a2a | The Mediator opts not to put in another Patient ID |
| 12a2a1 | The Mediator clicks Cancel |
| 12a2a2 | The addition of DICOM Attachments is aborted |
| 15d | The Mediator has imported the wrong set of DICOM studies (wrong |
| | Patient ID for DCM4CHEE input); or it is determined that the set of studies |
| | is not required for the current patient's case |
| 15d1 | The Mediator clicks on “Delete” on one of the DICOM studies |
| 15d2 | The Mediator is prompted that deleting this study will remove all studies |
| | in the same set (ie. all studies with the same Patient ID from DCM4CHEE) |
| 15d3 | The Mediator agrees to delete the study and the study and other |
| | associated studies are removed from PSOC (they remain in DCM4CHEE) |
| 15d4 | The Page reloads and the list of attachments no longer includes the set of |
| | studies erroneously added |
| 15d3a | The Mediator does not agree to delete the study |
| 15d3a1 | The set of studies is not removed from PSOC and is still available under |
| | the list of Attachments for the Patient's case |

TABLE 4
Update Patient Case

| Step No | Description |
|---|---|
| 1 | The Mediator clicks on a Patient Record from the list of Patient Records on |
| | the dashboard |
| 2 | The Mediator clicks on ‘Edit Patient Information’ |
| 3 | The Mediator is presented with a form pre-filled with current patient |
| | information |
| 4 | The Mediator modifies any incorrect entries. |
| 5 | The Mediator may choose to log the update to the narrative. In this case, |
| | the Mediator fills in the appropriate “Updates” information (see Updates |
| | Info below) |
| 6 | The clicks on ‘Save’ and validation is performed (see Patient Info Below) |
| 7 | The Mediator is redirected back to the read-only screen of the Patient |
| | Record they just modified. The screen will reflect any changes made by |
| | the Mediator to the Patient Information |
| 8 | The Mediator clicks on “Add Attachment” |
| 9 | The Mediator is presented with a form where they can input attachment |
| | details (see attachment info below) |
| 10 | The Mediator fills in the form, uploads a file, and clicks ‘Save’ and |
| | validation is performed |
| 11 | The Mediator is redirected back to the read-only screen of the Patient |
| | record they were just on. The screen will now show the additional |
| | attachment they just uploaded |
| 12 | The Mediator clicks on “Add DICOM Studies” |
| 13 | The Mediator is presented with a screen where they can fill in required |
| | DICOM Study information (see DICOM Studies info below). This page will |
| | also show read-only Patient information for the current patient record |
| 14 | On a seperate browser window or tab, or at an earlier time, the Mediator |
| | browses to the DCM4CHEE application |
| 15 | The Mediator searches for the Patient (in DCM4CHEE) they would like to |
| | add DICOM studies for in PSOC |
| 16 | The Mediator copies or memorises the Patient ID of the Patient in |
| | DCM4CHEE for later use in PSOC |
| 17 | Back on PSOC, the Mediator fills in this form and clicks “Save” and the |
| | system fetches all DICOM studies for the patient with the input Patient ID |
| | from the PACS server |
| 18 | The Mediator is taken back to the page showing read only Patient details. |
| | This page will be updated to include a list of DICOM studies fetched from |
| | the PACS server |
| 19 | The Mediator clicks on ‘Edit Narrative’ |
| 20 | The Mediator is presented with a form pre-filled with current narrative |
| | details. The page containing this form also shows current patient |
| | information and attachments in a read-only format |
| 21 | The Mediator modifies any incorrect entries and clicks ‘Save’ and |
| | validation is performed (see narrative info below) |
| 22 | The Mediator is redirected back to the read-only screen of the patient |
| | record whose narrative they just modified. The page will now reflect any |
| | changes made by the Mediator to the narrative of the patient record |
| 23 | The Mediator clicks on ‘Link to . . . ’ next to a narrative segment or |
| | update to which they would like to link a file or DICOM study |
| 24 | A pop-up appears listing current attachments to the patient record |
| 25 | The Mediator selects one of these attachments |
| 26 | The page reloads, showing the segment as linked to the document the |
| | Mediator chose. The page also shows the document in the attachment list |
| | with an indicator to show that it is linked to a narrative segment or update |

TABLE 4a
Variations on Table 4 steps

| Step No | Description |
|---|---|
| 4a | One or more validation constraints fails (see patient info below) |
| 4a1 | The Mediator is prompted to correct the offending entries |
| 4a2 | The Mediator corrects the entries |
| 4a3 | Retry step |
| 8a | One or more validation constraints fails (see attachment info below) |
| 8a1 | The Mediator is prompted to correct the offending entries |
| 8a2 | The Mediator corrects the entries |
| 8a3 | Retry step |
| 19a | One or more validation constraints fails (see narrative info below) |
| 19a1 | The Mediator is prompted to correct the offending entries |
| 19a2 | The Mediator corrects the entries |
| 19a3 | Retry step |
| 4b | The Mediator clicks ‘Cancel’ |
| 4b1 | The systems prompts the Mediator to confirm whether they would like to |
| | abort their modifications |
| 4b2 | If the Mediator confirms to abort, the system redirects them to the list of |
| | Patient records |
| 4b3 | If the Mediator does not confirm to abort, return to step 3 |
| 4c | The Mediator needs to re-order some of the narrative segments |
| 4c1 | The Mediator clicks on and drags the “drag handle” next to the particular |
| | narrative segment they want to re-order. The entire narrative segment |
| | will be moveable |
| 4c2 | The Mediator moves the particular segment to the position in should be |
| | in. |
| 4c3 | For any more segments that should be re-ordered, the mediator repeats |
| | step 4c1 and 4c2 above |
| 4c3 | Proceed to step 5. |
| 5a | The Mediator needs to delete an entry in the Updates section |
| 5a1 | The Mediator clicks on the delete button next to the Update entry they |
| | want to delete |
| 5a2 | The Mediator is prompted to confirm the deletion of the entry |
| 5a3 | The Mediator agrees and the Update entry is removed from the list |
| 5a4 | The Mediator repeats steps 5a1-5a3 above for any more Updates that |
| | need to be removed |
| 5a5 | Proceed to Step 6 |
| 5a3a | The Mediator does not confirm removal of an Updates entry |
| 5a3a1 | The Update entry is not removed from the list |
| 5a3a2 | Return to Step 5 |
| 10b | The Mediator clicks ‘Cancel’ |
| 10b1 | The systems prompts the Mediator to confirm whether they would like to |
| | abort their modifications |
| 10b2 | If the Mediator confirms to abort, the system redirects them to the read |
| | only screen for the patient and the attachment list will not be updated |
| 10b3 | If the Mediator does not confirm to abort, return to step 7 |
| 21b | The Mediator clicks ‘Cancel’ |
| 21b1 | The systems prompts the Mediator to confirm whether they would like to |
| | abort their modifications |
| 21b2 | If the Mediator confirms to abort, the system redirects them to the read |
| | only screen for the patient and the segment details will not be updated |
| 21b3 | If the Mediator does not confirm to abort, return to step 22 |
| 8a | There is more than one file to attach for this patient encounter |
| 8a1 | Details are filed out for each attachment and each file is selected |
| 8a2 | Continue from step seven (on returning to the read only screen the details |
| | of all the attachments added will be displayed |
| 21a | There are multiple segments to enter for one or more of the narrative |
| | blocks |
| 21a1 | The mediator enters the first segment details |
| 21a2 | The medaitor cliks on ‘add segment |
| 21a3 | The medaitor enters the details of the subsequent segment |
| 21a4 | 10a2-10a3 are repeated for each narrative segment |
| 21a5 | Return to step 21 |
| 21c | The Mediator has entered a segment that they should not have |
| 21c1 | The Mediator clicks on ‘Remove Segment’ |
| 21c2 | The Mediator is prompted if they are sure they want to remove the |
| | segment |
| 21c3 | The segment is removed from the narrative |
| 21c4 | Return to step 21 |
| 21c1a | The segment is linked to a document |
| 21c1a1 | The ‘Remove Segment’ button is not clickable and displays the tooltip |
| | “You can not remove this segment now because it has a linked document.” |
| 21c1a2 | Return to step 21 |
| 11a | The Mediator has added an Attachment in error |
| 11a1 | The Mediator clicks on ‘Delete Attachment’ |
| 11a2 | The Mediator is prompted if they are sure they want to delete the |
| | attachment |
| 11a3 | The Mediator confirms they want to delete the attachment |
| 11a4 | The Attachment is removed and is no longer available to the Patient |
| | Record |
| 11a5 | Return to step 11 |
| 25a | The Mediator has added an Attachment in error |
| 25a1 | The Mediator clicks on ‘Delete Attachment’ |
| 25a2 | The Mediator is prompted if they are sure they want to delete the |
| | attachment |
| 25a3 | The Mediator confirms they want to delete the attachment |
| 25a4 | The Attachment is removed and is no longer available to the Patient |
| | Record |
| 25a5 | Return to step 25 - on return to the read only screen the attachment is no |
| | longer shown in the list of attachments |
| 25a1a | The attachment is already linked to one or more segments |
| 25a1a1 | The button is not clickable and displays the tooltip ‘please unlink this |
| | attachment before deleting it’ |
| 25a1a2 | Return to step 25a2 |
| 25b | More than one segment relates to one of the attachments |
| 25b1 | The mediator repeats step 13-15 for each segment to which the |
| | attachment relates chosing the same attachment in the pop up each time. |
| 25b2 | Return to step 25 |
| 23a | The segment is already linked to an attachment |
| 23a1 | The segment displays a link to the attached document and a button to |
| | ‘Unlink’ the document |
| 14b | The segment is already linked to an attachment |
| 14b1 | The Mediator clicks on “Unlink” |
| 14b2 | Return to step 24 |
| 26a | The document is linked to more than one segment |
| 26a1 | The segment is updated as above but the document list is not updated as |
| | the document indicator still shows that it is linked to a document |
| 18a | The Mediator has imported the wrong set of DICOM studies (wrong |
| | Patient ID for DCM4CHEE input); or it is determined that the set of studies |
| | is not required for the current patient's case |
| 18a1 | The Mediator clicks on “Delete” on one of the DICOM studies |
| 18a2 | The Mediator is prompted that deleting this study will remove all studies |
| | in the same set (ie. all studies with the same Patient ID from DCM4CHEE) |
| 18a3 | The Mediator agrees to delete the study and the study and other |
| | associated studies are removed from PSOC (they remain in DCM4CHEE) |
| 18a4 | The Page reloads and the list of attachments no longer includes the set of |
| | studies erroneously added |
| 18a3a | The Mediator does not agree to delete the study |
| 18a3a1 | The set of studies is not removed from PSOC and is still available under |
| | the list of Attachments for the Patient's case |

TABLE 5
Redaction

| Step No. | Description |
|---|---|
| 1 | The Mediator clicks on “Add a File Attachment” |
| 2 | The Mediator is presented with a screen in which they can fill in required |
| | File Attachment information including selecting the file to attach |
| 3 | The Mediator clicks ‘choose file’ to select the image they want to upload |
| | from their files |
| 4 | The uploaded image appears on the screen with an editing tool bar |
| 5 | The Mediator can redact, rotate, crop and save the image as necessary. |
| | The Mediator fills in the rest of the fields and clicks “Save” and validation |
| | is performed |

TABLE 5a
Variations on Table 5 steps

| Step No. | Description |
|---|---|
| 4a | The Mediator does not click the save icon on the tool bar |
| 4a1 | The image is saved without the changes |
| 4a2 | The Mediator deletes the attachment and clicks on ‘Add file attachment |
| | again |
| 4a3 | The Mediator repeats steps 1-4 |
| 4a4 | The mediator edits the image and clicks save on the toolbar |
| 4a5 | The Mediator clicks upload |
| 4a6 | The Mediator has completed the entry and returns to the read only page |
| | to complete the narrative |
| 5a | The Mediator clicks ‘Cancel’ |
| 5a1 | The systems prompts the Mediator to confirm whether they would like to |
| | abort their modifications |
| 5a2 | If the Mediator confirms to abort, the system redirects them to the read |
| | only screen for the patient and the File Attachment list will not be updated |
| 5a3 | If the Mediator does not confirm to abort, return to step 7 |

TABLE 6
File Attachments

| Step No. | Description |
|---|---|
| 1 | The Mediator clicks on “Add Attachment” |
| 2 | The Mediator is presented with a form where they can input attachment |
| | details (see attachment info below) |
| 3 | The Mediator fills in the form and selects a file for upload |
| 4 | The Mediator selects a file for upload. The mediator will follow a series of |
| | steps depending on the file type. They are detailed in variations below |
| 5 | The mediator clicks “Upload” and validation is performed |
| 6 | The Mediator is redirected back to the read-only screen of the Patient |
| | record they were just on. The screen will now show the additional |
| | attachment they just uploaded |
| 7 | The Mediator wishes to modify an existing attachment |
| 8 | The Mediator clicks on the “Edit” icon next to the attachment they wish to |
| | modify |
| 9 | The Mediator is presented with a form where they can input attachment |
| | details (see attachment info below) as in step 2 above; only the details of |
| | the attachment are pre-filled |
| 10 | The Mediator modifies entries in the form as desired |
| 11 | Optionally, the mediator modifies the attachment, following specific steps |
| | depending on the file type. The steps are detailed in variations below |
| 12 | Proceed to step 5 |

TABLE 6a
Variations on Table 6 steps

| Step No | Description |
|---|---|
| 4a | The file is an image |
| 4a1 | The form expands to display the image and a set of tools that would allow |
| | the mediator to manipulate the image |
| 4a2 | The mediator rotates, crops or redacts the image as necessary |
| 4a3 | The mediator clicks on the save icon |
| 4a4 | The image is redisplayed on the form with the mediator's changes. The |
| | image manipulation tools are now no longer available |
| 4a5 | Proceed to step 5 |
| 4a5a | The image is part of a series of images from a scanned document that the |
| | mediator intends to upload as a single attachment |
| 4a5a1 | The mediator clicks “Append” |
| 4a5a2 | A file chooser dialog appears, allowing the mediator to select the next |
| | image in the series of images |
| 4a5a3 | Proceed to step 4a2 |
| 4b | The file is a PDF document |
| 4b1 | A dialog appears, informing the mediator to wait as the selected document |
| | is being pre-processed |
| 4b2 | The form expands and now displays the first page of the document as an |
| | image on the web page. Additionally, a set of image manipulation tools is |
| | available |
| 4b3 | The mediator rotates, crops or redacts the image as desired |
| 4b4 | The mediator clicks on the save icon |
| 4b5 | The image is redisplayed on the form with the mediator's changes. The |
| | image manipulation tools are now no longer available |
| 4b6 | Proceed to step 5 |
| 4b6a | The PDF document has multiple pages that require manipulation |
| 4b6a1 | The mediator clicks “Next”. |
| 4b6a2 | The form now displays the next page of the document as an image on the |
| | web page and the image manipulation tools are loaded |
| 4b6a3 | The mediator follows steps 4b3 through 4b5 to manipulate and save the |
| | changes to the page |
| 4b6a4 | The mediator will repeat steps 4b6a1 through 4b6a3 for each page that |
| | the mediator wishes to modify |
| 4b6a5 | Proceed to step 5 |
| 4c | The file is a video file |
| 4c1 | There are no special steps to follow for video files |
| 4c2 | Proceed to step 5 |
| 11a | The attachment is of a video file |
| 11a1 | Editing is not supported in video files. Proceed to step 12 |
| 11b | The attachment is of a PDF file |
| 11b1 | The first page of the attachment is loaded as an image on the web page as |
| | in step 4b2 above. Image manipulation tools are also loaded |
| 11b2 | The mediator rotates, crops or redacts the image as desired |
| 11b3 | The mediator clicks on the save icon |
| 11b4 | The image is redisplayed on the form with the mediator's changes. The |
| | image manipulation tools are now no longer available |
| 11b5 | Proceed to step 5 |
| 11b5a | The PDF document has multiple pages that require manipulation |
| 11b5a1 | The mediator clicks “Next”. |
| 11b5a2 | The form now displays the next page of the document as an image on the |
| | web page and the image manipulation tools are loaded |
| 11b5a3 | The mediator follows steps 4b3 through 4b5 to manipulate and save the |
| | changes to the page |
| 11b5a4 | The mediator will repeat steps 4b6a1 through 4b6a3 for each page that |
| | the mediator wishes to modify |
| 11b5a5 | Proceed to step 5 |

TABLE 7
Generate Patient Share Link

| Step No | Description |
|---|---|
| 1 | The Mediator clicks on the Patient Record they would like to |
| | share from the list of Patient Records |
| 2 | The Mediator is presented with a page showing the narrative of |
| | the patient's case |
| 3 | The Mediator clicks on the “Share Links” button. A modal pops |
| | up showing the Mediator a form to generate a new share link and |
| | an empty list under the section “Current Share Links”. |
| 4 | The Mediator fills in the form to generate a new share link as per |
| | “Share Link info” below and clicks “Generate” |
| 5 | The link is generated and added to section labeled “Current |
| | Share Links” in the modal |
| 6 | The Mediator right clicks on the share link they just generated |
| | and copies it for sending to the patient. |
| 7 | The Mediator sends this link to the patient for review |

TABLE 7a
Variations on Table 7 steps

| Step No | Description |
|---|---|
| 3a | The Mediator has previously generated a share link |
| 3a1 | The list under the section “Current Share Links” also shows |
| | the previously generated link(s). |
| 4a | The Mediator opts to generate the share link at a later time |
| 4a1 | The Mediator quits the modal window by clicking the close |
| | button or clicking outside the modal window |
| 4a2 | Return to step 1 |
| 6a | The mediator follows the link they just generated |
| 6a1 | A new window opens showing the mediator a view of the |
| | narrative of the patient's case as would be presented to |
| | the patient |
| 6b | The Mediator opts to send the share link later |
| 6b1 | The Mediator quits the modal window by clicking the close |
| | button or clicking outside the modal window |
| 6b2 | Later, when the Mediator intends to send the share link, the |
| | mediator follows steps 1-3 above |
| 6b3 | Proceed to step 6 |

TABLE 8
Approve Sharing of Case

| Step No. | Description |
|---|---|
| 1 | The Patient clicks on the share link they received from the |
| | Mediator on email |
| 2 | They are presented with a view of their Patient Record in a |
| | read-only format and with no options to modify the record |
| 3 | The Patient clicks on any of the attached documents |
| 4 | A new window opens to display the attached document (if |
| | their browser allows it) or they are prompted to download |
| | the attachment |
| 5 | The Patient, having sufficiently reviewd the narrative and |
| | finding it satisfactory, approves the narrative for sharing |
| | with a specialist by communicating this to the Mediator |

TABLE 8a
Variations on Table 8 steps

| Step No | Description |
|---|---|
| 2a | The share link has been retired |
| 2a1 | The Patient is presented with an error page explaining that |
| | access to the patient's case is not allowed via the given link |
| 2a2 | The Patient follows up with the Mediator about access to the |
| | patient's case |
| 2a3 | Proceed to step 1 |
| 4a | The attachment is a DICOM study |
| 4a1 | A new window opens and displays the images in the study in a |
| | specialized viewer. |
| 5a | The Patient finds fault with the narrative or finds it to be |
| | otherwise unsatisfactory |
| 5a1 | The Patient informs the Mediator of the faults in the narrative |
| 5a2 | The Mediator ammends the narrative as per (Update Patient |
| | Case) |
| 5a3 | The Mediator will inform the patient to review the case again |
| | after addressing the identified issues |
| 5a4 | Proceed to step 1 |

TABLE 9
Generate Specialist Share Link

| Step No. | Description |
|---|---|
| 1 | The Mediator clicks on the Patient Record they would like to |
| | share from the list of Patient Records |
| 2 | The Mediator is presented with a page showing the narrative |
| | of the patient's case |
| 3 | The Mediator clicks on the “Share Links” button. A modal |
| | pops up showing the Mediator a form to generate a new share |
| | link and, under the section “Current Share Links”, a link |
| | previously generated for approval by the patient. |
| 4 | The Mediator fills in the form to generate a new share link as |
| | per “Share Link info” below and clicks “Generate” |
| 5 | The link is generated and added to section labeled “Current |
| | Share Links” in the modal |
| 6 | The Mediator right clicks on the share link they just generated |
| | and copies it for sending to the specialist. |
| 7 | The Mediator sends this link to the specialist for review |

TABLE 9a
Variations on Table 9 steps

| Step No | Description |
|---|---|
| 3a | Other than the Patient Share Link, the Mediator has previously |
| | generated another Share Link |
| 3a1 | The other generated link is also shown in the list labeled |
| | “Current Share Links” |
| 3b | The Mediator has not previously generated a Patient View share |
| | link |
| 3b1 | The list in the section “Current share links” does not contain the |
| | share link |
| 3b2 | Proceed to step 4 |
| 4a | The Mediator opts to generate the share link at a later time |
| 4a1 | The Mediator quits the modal window by clicking the close |
| | button or clicking outside the modal window |
| 4a2 | Return to step 1 |
| 4b | The Mediator wants to share the record with a second specialist |
| 4b1 | The Mediator repeats step 4 above to generate the additional |
| | share links for the same patient record |
| 4b3 | Proceed to step 5 |
| 6a | The Mediator follows the Link they just generated |
| 6a1 | A new window opens showing the Mediator a view of the |
| | narrative as would be presented to the specialist |
| 6b | The Mediator opts to send the share link later |
| 6b1 | The Mediator quits the modal window by clicking the close |
| | button or clicking outside the modal window |
| 6b2 | Later, when the Mediator intends to send the share link, |
| | the mediator follows steps 1-3 above |
| 6b3 | Proceed to step 6 |

TABLE 10
Review Patient Case

| Step No. | Description |
|---|---|
| 1 | The Specialist clicks on the link they recieved from the |
| | mediator |
| 2 | The Specialist is presented with a screen where they can |
| | review the narrative created for the patient's case |
| 3 | The Specialist clicks on any of the attached documents |
| 4 | A new window opens to display the attached document (if |
| | their browser allows it) or they are prompted to download |
| | the attachment |
| 5 | The Specialist can then later submit their diagnosis based on |
| | the information they have been able to review |

TABLE 10a
Variations on Table 10 steps

| Step No | Description |
|---|---|
| 2a | The share link has been retired |
| 2a1 | The Specialist is presented with an error page explaining that |
| | access to the patient's case is not allowed via the given link |
| 2a2 | The Specialist follows up with the Mediator about access to |
| | the patient's case |
| 2a3 | Proceed to step 1? |
| 4a | The attachment is a DICOM study |
| 4a1 | A new window opens which contains an integrated DICOM |
| | viewer which allows the specialist to view the images contained |
| | in the DICOM Study |
| 5a | The Specialist finds that they need more information on the |
| | narrative of the patient's case |
| 5a1 | The specialist communicates this to the Mediator |
| 5a2 | The Mediator will update the narrative where possible as per |
| | (Update Patient Case) |
| 5a3 | Proceed to step 1 |

TABLE 11
Upload Mediator Report

| Step No | Description |
|---|---|
| 1 | The Mediator selects the respective patient record from the |
| | list of patient records |
| 2 | The Mediator is presented with a view of the Patient Record |
| 3 | The Mediator clicks “Add an Attachment” |
| 4 | A form is presented allowing the mediator to input the |
| | description and date of their report as per Attachment |
| | Info below |
| 5 | The Mediator fills in the form, clicks save and validation is |
| | performed |
| 6 | The Mediator is taken back to the view of the patient record |
| | with their report added to the attachment list |
| 7 | The Mediator then clicks on the “Link Attachment” button in |
| | the section titled “Mediator Reports” |
| 8 | A dropdown appears listing the current attachments to the |
| | Patient Record |
| 9 | The Mediator selects their report from the dropdown |
| 10 | The page reloads showing the Mediator Report in the “Mediator |
| | Reports” section |
| 11 | The Mediator may then make an Updates entry to the narrative |
| | as per Update Patient Case |

TABLE 11a
Variations on Table 11 steps

| Step No | Description |
|---|---|
| 5a | One or more validation constraints fails |
| 5a1 | The Mediator is prompted to correct the offending entries |
| 5a2 | The Mediator corrects the form entries to resolve validation |
| | errors |
| 5a3 | Return to Step 5 |
| 5b | The Mediator clicks ‘Cancel’ |
| 5b1 | The systems prompts the Mediator to confirm whether they |
| | would like to abort their modifications |
| 5b2 | If the Mediator confirms to abort, the system redirects them to |
| | the read only screen for the patient and the File Attachment |
| | list will not be updated |
| 5b3 | If the Mediator does not confirm to abort, return to step 5 |
| 6a | The Mediator has uploaded an attachment in error |
| 6a1 | The Mediator clicks the “Delete” button next to the |
| | attachment they have uploaded in error |
| 6a2 | The mediator is prompted to confirm deletion of the |
| | attachment |
| 6a3 | The Mediator confirms, the attachment is removed, the page |
| | reloads and the attachment is no longer listed under the |
| | “Attachments” section of the patient record |
| 6a4 | The Mediator proceed to upload the correct attachment, |
| | following from step 3 above |
| 6a1a | The attachment is linked as a Mediator report |
| 6a1a1 | The “Delete” button next to the attachment is disabled, |
| | showing the tooltip “The attachment can not be deleted |
| | because it is linked to one or more segments or reports” |
| 6a1a2 | The Mediator unlinks the report as per steps 10a1-10a3 below |
| 6a1a3 | The “Delete” button next to the attachment is now active |
| 6a1a4 | Continue from step 6a1 above |
| 6a1a3a | The attachment is linked to a narrative segment |
| 6a1a3a1 | The “Delete” button next to the attachment is disabled, |
| | showing the tooltip “The attachment can not be deleted |
| | because it is linked to one or more segments or reports” |
| 6a1a3a2 | The mediator clicks on the “Unlink” button next to |
| | the narrative segment to which the attachment is linked |
| 6a1a3a3 | The attachment is unlinked and the page reloads |
| 6a1a3a4 | The “Delete” button next to the attachment is now |
| | active |
| 6a1a3a5 | Continue from step 6a1 above |
| 6a1a3a4a | The attachment is linked to another narrative segment |
| 6a1a3a4a1 | The Mediator follows steps 6a1a3a1-6a1a3a3 above for |
| | each segment to which the attachment is linked |
| 6a1a3a4a2 | Continue from step 6a1 above |
| 10a | The Mediator has linked an attachment in error |
| 10a1 | The Mediator clicks on the “Unlink” button next to the |
| | Mediator report that they have wrongly linked |
| 10a2 | The Report is unlinked |
| 10a3 | The Page reloads and the wrongly linked report is no longer |
| | listed under “Mediator Reports” |
| 10a4 | The Mediator then links to the correct report, following from |
| | step 7 above |

TABLE 12
Upload Specialist Report

| Step No | Description |
|---|---|
| 1 | The Mediator selects the respective patient record from the list |
| | of patient records |
| 2 | The Mediator is presented with a view of the Patient Record |
| 3 | The Mediator clicks “Add an Attachment” |
| 4 | A form is presented allowing the mediator to input the |
| | description and date of the specialist's report as per |
| | Attachment Info below |
| 5 | The Mediator fills in the form, clicks save and validation is |
| | performed |
| 6 | The Mediator is taken back to the view of the patient record |
| | with their report added to the attachment list |
| 7 | The Mediator then clicks on the “Link Attachment” button |
| | in the section titled “Specialist Reports” |
| 8 | A dropdown appears listing the current attachments to the |
| | Patient Record |
| 9 | The Mediator selects their report from the dropdown |
| 10 | The page reloads showing the Specialist Report in the |
| | “Specialist Reports” section |
| 11 | The Mediator may then make an Updates entry to the narrative |
| | as per Update Patient Case |

TABLE 12a
Variations on Table 12 steps

| Step No | Description |
|---|---|
| 5a | One or more validation constraints fails |
| 5a1 | The Mediator is prompted to correct the offending entries |
| 5a2 | The Mediator corrects the form entries to resolve validation |
| | errors |
| 5a3 | Return to Step 5 |
| 5b | The Mediator clicks ‘Cancel’ |
| 5b1 | The systems prompts the Mediator to confirm whether they |
| | would like to abort their modifications |
| 5b2 | If the Mediator confirms to abort, the system redirects them to |
| | the read only screen for the patient and the File Attachment |
| | list will not be updated |
| 5b3 | If the Mediator does not confirm to abort, return to step 5 |
| 6a | The Mediator has uploaded an attachment in error |
| 6a1 | The Mediator clicks the “Delete” button next to the |
| | attachment they have uploaded in error |
| 6a2 | The mediator is prompted to confirm deletion of the |
| | attachment |
| 6a3 | The Mediator confirms, the attachment is removed, the page |
| | reloads and the attachment is no longer listed under the |
| | “Attachments” section of the patient record |
| 6a4 | The Mediator proceed to upload the correct attachment, |
| | following from step 3 above |
| 6a1a | The attachment is linked as a Specialist report |
| 6a1a1 | The “Delete” button next to the attachment is disabled, |
| | showing the tooltip “The attachment can not be deleted |
| | because it is linked to one or more segments or reports” |
| 6a1a2 | The Mediator unlinks the report as per steps 10a1-10a3 below |
| 6a1a3 | The “Delete” button next to the attachment is now active |
| 6a1a4 | Continue from step 6a1 above |
| 6a1a3a | The attachment is linked to a narrative segment |
| 6a1a3a1 | The “Delete” button next to the attachment is disabled, |
| | showing the tooltip “The attachment can not be deleted |
| | because it is linked to one or more segments or reports” |
| 6a1a3a2 | The mediator clicks on the “Unlink” button next to the |
| | narrative segment to which the attachment is linked |
| 6a1a3a3 | The attachment is unlinked and the page reloads |
| 6a1a3a4 | The “Delete” button next to the attachment is now |
| | active |
| 6a1a3a5 | Continue from step 6a1 above |
| 6a1a3a4a | The attachment is linked to another narrative segment |
| 6a1a3a4a1 | The Mediator follows steps 6a1a3a1-6a1a3a3 above |
| | for each segment to which the attachment is linked |
| 6a1a3a4a2 | Continue from step 6a1 above |
| 10a | The Mediator has linked an attachment in error |
| 10a1 | The Mediator clicks on the “Unlink” button next to the |
| | Specialist report that they have wrongly linked |
| 10a2 | The Report is unlinked |
| 10a3 | The Page reloads and the wrongly linked report is no longer |
| | listed under “Mediator Reports” |
| 10a4 | The Mediator then links to the correct report, following from |
| | step 7 above |

TABLE 13
Retire Share Link

| Step No. | Description |
|---|---|
| 1 | The Mediator selects the Patient Record that is the target of |
| | a link they would like to retire from the list of patient records |
| 2 | The Mediator is presented with a page showing the Patient |
| | Record |
| 3 | The Mediator clicks on the “Share Links” button |
| 4 | A modal pops up showing existing share links under the |
| | “Current Share Links” header |
| 5 | The Mediator clicks on the “Retire this Link” button for |
| | the Patient View share link |
| 6 | The link is retired and the list of share links reflects this. |
| 7 | Access to the Patient Record is now no longer permitted via |
| | the Patient View share link |
| 8 | The Mediator clicks on the “Retire this Link” button for the |
| | Specialist View share link |
| 9 | The link is retired and the list of share links reflects this. |
| 10 | Access to the Patient Record is now no longer permitted via |
| | the Specialist View share link |

TABLE 13a
Variations on Table 13 steps

| Step No | Description |
|---|---|
| 6a | The share link is already retired |
| 6a1 | The “Retire this link” button is disabled and cannot be |
| | clicked on |
| 6b | The Patient has requested to maintain access to the Patient |
| | Record via the share link |
| 6b1 | The Mediator skips this link and does not retire it |
| 6b2 | The Patient record remains accessible via the Patient View |
| | share link |
| 6b3 | Proceed to step 8 |
| 6b4 | The Patient Record will no longer be accessible via the |
| | Specialist Share Link but will be accessible via the |
| | Patient Share Link |
| 8a | There is more than one Specialist View share link |
| 8a1 | The Mediator repeats steps 8 and 9 above for each Specialist |
| | View share link |
| 8a1a | A specialist still requires access to the patient record via |
| | the respective share link |
| 8a1a1 | The Mediator does not retire the link |
| 8a1a2 | The patient record is still accessible via the respective share link |
| 8a1a3 | Unless the patient share link is still active as per variation 6b, |
| | access to the patient record is no longer accessible via the patient |
| | share link but is accessible via the specialist share link |

TABLE 14
Encryption

| Steps | Description | Outcome |
|---|---|---|
| 1 | Inspect existing records in the database | The data should be encrypted |
| 2 | Load PSOC and go to the list of patient | The list should contain |
| | records | decrypted/human-readable |
| | | entries |
| 3 | Click on a Patient Record from the List | The Patient Record shown should |
| | to view the summary screen | contain decrypted/human- |
| | | readable entries |
| 4 | Create a new Patient Record (As | Should save normally |
| | described in New Case) - filling in at | |
| | least all required patient information | |
| 5 | View the record just created in the | The data should be encrypted |
| | database | |
| 6 | Modify patient information for an | Should save normally |
| | existing record (Edit screen) | |
| 7 | View the modified record in the | The data should be encrypted |
| | database | |
| 8 | Click on a Share Link for a given patient | The data should be human |
| | record (read-only screen) | readable |

What is claimed is:

1. A computer-implemented method for managing a patient's medical records, the method comprising:
receiving at a server a plurality of narratives pertaining to the patient, each narrative comprising an originator identity, a date, and a data item, wherein each data item comprises a narrative portion and a supporting data portion, and wherein at least one supporting data portion from at least one of the plurality of narratives comprises a medical image; and
organizing the plurality of narratives into a structured narrative and formatting the structured narrative for display;
wherein the server is configured to provide remote access to the structured narrative via a computer network,
and wherein display of the structured narrative comprises a hyperlink to the medical image.

2. The method of claim 1, wherein the narrative portion of each data item is text and is selected from: a diagnosis; a symptom; an observation; a description or selection from an investigation; a description or selection from a report; a description or selection from a prescription; and a description or selection from a medical image.

3. The method of claim 1, wherein each originator identity is selected from: a physician; a clinical officer; a nurse; a medical technician; and a patient.

4. The method of claim 1, wherein at least two of the plurality of narratives are received from different originators.

5. The method of claim 1, wherein the structured narrative is organized as a medical history divided into narrative groups, and within each narrative group narratives are organized chronologically.

6. The method of claim 1, wherein each supporting data portion is selected from patient data and general data.

7. The method of claim 1, wherein each supporting data portion is selected from: a medical scan image; a picture or scan of a report; a picture or scan of a test result; a photo or scan of a photo; a drug description; a photo or scan of a prescription; and a photo or scan of a referral.

8. A computer-based patient medical record system comprising: a structured narrative disposed on a server and configured to be displayed, the structured narrative comprising a plurality of narratives pertaining to a patient, each narrative comprising an originator identity, a date, and a data item, wherein each data item comprises a narrative portion and a supporting data portion, and wherein at least one supporting data portion from at least one of the plurality of narratives comprises a hyperlinked medical image.

9. The system of claim 8, wherein the structured narrative is configured to be displayed on a single web page.

10. An improved mobile computer device comprising a camera and a communications module, wherein the improvement comprises: machine-readable instructions configured to connect the device to a network and access a structured narrative located on a server, wherein the structured narrative is configured to be displayed on the mobile computer device, and wherein the structured narrative comprises a plurality of narratives pertaining to a patient, each narrative comprising an originator identity, a date, and a data item, wherein at least one data item from at least one of the plurality of narrative comprises a hyperlinked medical image.
